(19) United States
(12) Patent Application Publication
(10) Pub. No.: US 2024/0144029 A1
(43) Pub. Date: May 2, 2024

(54) SYSTEM FOR SECURE AND EFFICIENT FEDERATED LEARNING

(71) Applicant: Garena Online Private Limited, Singapore (SG)

(72) Inventors: Haozhe FENG, Singapore (SG); Tianyu PANG, Singapore (SG); Chao DU, Singapore (SG); Shuicheng YAN, Singapore (SG); Min LIN, Singapore (SG)

(21) Appl. No.: 18/464,126

(22) Filed: Sep. 8, 2023

(30) Foreign Application Priority Data
Sep. 29, 2022 (SG) 10202251220D
Dec. 23, 2022 (SG) 10202260574Y

(51) Int. Cl. G06N 3/098

(52) U.S. Cl. CPC G06N 3/098

(57) ABSTRACT

A method for training a machine learning model is described, comprising receiving, for each perturbation of a plurality of perturbations of model parameters of a starting version of the machine learning model, a change of loss of the machine learning model caused by the perturbation for a set of training data determined by feeding the set of training data to one or more perturbed versions of the machine learning model, estimating a gradient of the loss of the machine learning model with respect to the model parameters from the determined changes of loss and updating the starting version of the machine learning model to an updated version of the machine learning model by changing the model parameters in a direction for which the estimated gradient indicates a reduction of loss.

### CROSS REFERENCE RELATED TO RELATED APPLICATIONS

This patent application claims the benefit and priority of Singaporean Patent Application No. 10202260574Y filed with the Intellectual Property Office of Singapore on Dec. 23, 2022 and claims the benefit and priority of Singaporean Patent Application No. 10202251220D filed with the Intellectual Property Office of Singapore on Sep. 29, 2022, the disclosures of which are incorporated by reference herein in their entireties as part of the present application.

### TECHNICAL FIELD

Various aspects of this disclosure relate to systems and methods for training a machine learning model.

BACKGROUND

Federated learning (FL) provides general principles for decentralized clients to train a server model collectively without sharing local data. FL is a promising framework with practical applications, but its standard training paradigm requires the clients to back-propagate through the model to compute gradients. Since these clients are typically edge devices and not fully trusted, they may lack the computational and storage resources required to execute back-propagation. For example, any trusted execution environment may not have sufficient memory to store the data required to execute back-propagation. Performing FL with conventional techniques therefore may require accepting unreasonable constraints on the allowed size of the data model or executing training outside of a trusted environment and subjecting the model to white-box vulnerability (i.e. vulnerability against attacks where an attacker has high knowledge of the attacked application, including e.g. access to source code).

Accordingly, approaches for federated learning with less computational burden on the client devices and higher security are desirable.

### SUMMARY

Various embodiments concern a method for training a machine learning model is described, including receiving, for each perturbation of a plurality of perturbations of model parameters of a starting version of the machine learning model, a change of loss of the machine learning model caused by the perturbation for a set of training data determined by feeding the set of training data to one or more perturbed versions of the machine learning model, estimating a gradient of the loss of the machine learning model with respect to the model parameters from the determined changes of loss and updating the starting version of the machine learning model to an updated version of the machine learning model by changing the model parameters in a direction for which the estimated gradient indicates a reduction of loss.

According to one embodiment, the method includes distributing the model parameters of the machine learning model to a plurality of clients for the clients to determines one or more of the changes of loss.

According to one embodiment, the server transmits one or more seeds to the clients for the clients to determine the perturbations using the one or more seeds.

According to one embodiment, the method comprises estimating the gradient of the loss of the machine learning model with respect to the model parameters from the changes of loss determined by the clients and updating the starting version of the machine learning model to the updated version of the machine learning model by changing the model parameters in a direction for which the estimated gradient indicates a reduction of loss.

According to one embodiment, the method includes performing multiple iterations including, in each iteration from a first to a last iteration, receiving, for each perturbation of a plurality of perturbations of model parameters of a respective starting version of the machine learning model, a change of loss of the machine learning model caused by the perturbation for a set of training data determined by feeding the set of training data to one or more perturbed versions of the machine learning model, estimating a gradient of the loss of the machine learning model with respect to the model parameters from the determined changes of loss and updating the respective starting version of the machine learning model to a respective updated version of the machine learning model by changing the model parameters in a direction for which the estimated gradient indicates a reduction of loss, wherein, for each iteration but the last iteration, the respective updated version of the machine learning model of the iteration is the starting version of the machine learning model for the next iteration.

According to one embodiment, the method includes estimating the gradient of the loss of the machine learning model with respect to the model parameters from the determined changes of loss according to Stein's identity.

According to one embodiment, the machine learning model is a neural network and the model parameters are neural network weights.

According to one embodiment, a server is provided configured to perform the method any one of the embodiments described above.

According to one embodiment, a computer program element is provided including program instructions, which, when executed by one or more processors, cause the one or more processors to perform the method of any one of the embodiments described above.

According to one embodiment, a computer-readable medium is provided including program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 illustrates a system for federated learning.

FIG. 2 shows a data flow diagram illustrating back-propagation-free federated learning according to an embodiment.

FIG. 3 illustrates a trusted execution environment implemented on a client device embodiment.

FIG. 4 shows a flow diagram illustrating a method for training a machine learning model according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

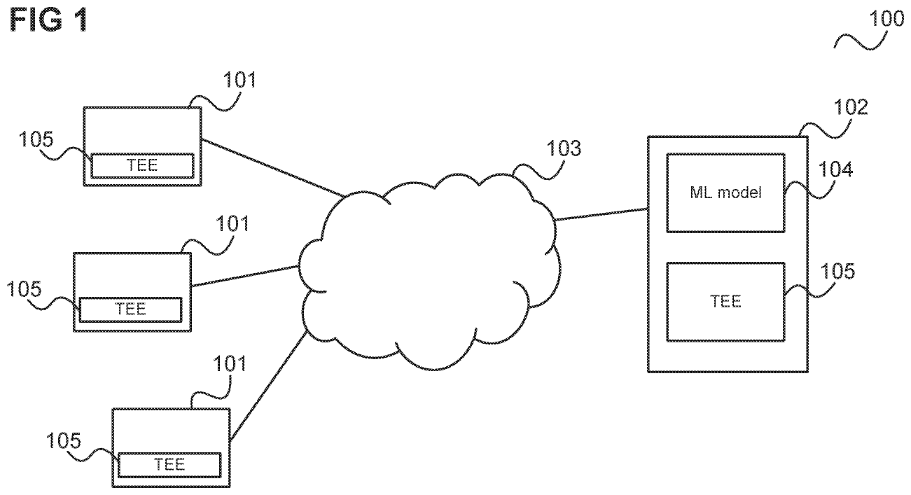

FIG. 1 illustrates a system 100 for federated learning.

The system 100 includes a plurality of client devices 101 (also simply referred to as “clients” in the following) and a server device 102 (also simply referred to as “server” in the following) to which the clients 101 are connected via a communication network 103. The server 102 stores a machine learning model 104 which should be trained (also referred to as “server model” in the following). When the machine learning model 104 is considered to be centrally stored on the server 102 the clients can be seen as decentralized clients.

Federated learning (FL) allows decentralized clients to collaboratively train a server model. According to a standard training approach, in each of multiple training rounds (i.e. iterations), the clients 101 (or a selected subset of them) compute model gradients or (model) updates on their local private datasets, without explicitly exchanging sample points with the server 102. While FL with this training approach describes a promising blueprint and has several applications, it is gradient-based and thus requires the clients 101 to locally execute back-propagation, which leads to the following practical limitations:
(i) Overhead for edge devices: the clients 101 in FL are typically edge devices, such as mobile phones and IoT (Internet of Things) sensors, whose hardware is primarily optimized for inference-only purposes, rather than for back-propagation. Due to the limited resources, computationally affordable machine learning models running on edge devices are typically quantized and pruned, making exact back-propagation difficult. In addition, standard implementations of back-propagation rely on either forward-mode or reverse-mode auto-differentiation in contemporary machine learning packages, which increases storage requirements.
(ii) White-box vulnerability. To facilitate gradient computing, the server 102 regularly distributes its model status to the clients 101, but this white-box exposure of the model renders the server vulnerable to, e.g., poisoning or inversion attacks from malicious clients. An approach to address this issue is to exploit trusted execution environments (TEEs) in FL, which can isolate the model status within a black-box secure area and significantly reduce the success rate of malicious evasion. However, TEEs are highly memory-constrained, while back-propagation is memory-intensive including, for example, because of the need to restore intermediate states.

In view of the above and in accordance with various embodiments, a system for back-propagation-free federated learning is provided in which back-propagation is replaced by multiple forward (or inference) processes to estimate gradients.

The system for back-propagation-free federated learning, in accordance with various embodiments, is
1) memory-efficient and reduces uploading bandwidth requirements;
2) more compatible with inference-only hardware optimization and model quantization or pruning; and
3) well-suited to trusted execution environments, because the clients 101 associated with the system only execute forward propagation and return a set of scalars to the server 102.

Experiments show that models trained by the system can achieve empirically comparable performance to conventional FL models.

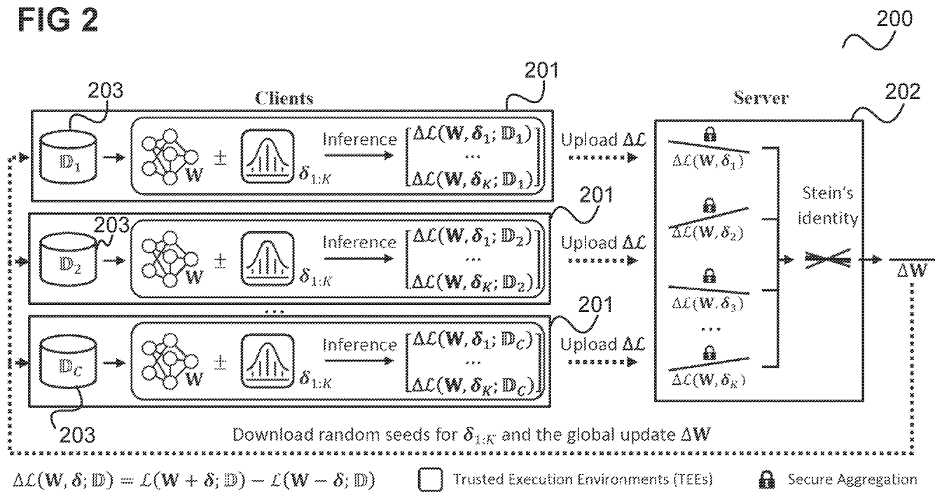

FIG. 2 shows a data flow diagram 200 illustrating back-propagation-free federated learning according to an embodiment. Clients 201 corresponding to the clients 101 of FIG. 1 and a server 202 corresponding to the server 102 of FIG. 1 are involved in data flow. The data flow diagram 200 of FIG. 2 is described in relation to the clients 101 and the server 102 of FIG. 1 for illustrative purposes. Other embodiments may be applicable to other environments including those environments with alternative client devices (e.g., virtual machines), additional client devices, and/or fewer client devices. For example, the client devices may have multiple private datasets in some embodiments. Additionally, the server 202 may be embodied in one or more processors, components, computing devices, and/or systems which may be in communication via one or more networks.

As explained with reference to FIG. 1, the server 202 stores a machine learning model. The machine learning model is given by the values of model parameters W (e.g. the weights of a neural network). Further, it is assumed that each client 201 has its own private dataset 203, denoted as [symbol] _{c} for the client with number c.

As illustrated, the system for back-propagation-free federated learning according to various embodiments includes the following:
(1) Each client 201 locally perturbs the model parameters a number of times (e.g., 2K times) as W±δₖ to generated a number of perturbed versions of the models. The server 202 for example sends one or more seeds (e.g., numbers or vectors to initialize a pseudorandom number generator, also referred to as “random” seeds) to the clients 201 for generating {δₖ}ₖ₌₁^{K}. For example, each client 201 downloads one or more random seeds to locally generate perturbations ±δ_{1:K}.
(2) Each client executes forward processes on the perturbed models using its private dataset [symbol] _{c} to obtains K loss differences {Δ [symbol] (W, Γₖ; [symbol] _{c})}ₖ₌₁^{K} and provides (uploads) them to the server 202. In some embodiments, each loss difference Δ [symbol] (W, δₖ; [symbol] _{c}) is a floating-point number. Accordingly, the client 201 and/or the server 202 may identify an uploading bandwidth available and adjust K to fit the uploading bandwidth.
(3) The server 202 receives the loss differences from the clients and recovers the perturbations ±δ_{1:K} using the same seeds as provided to the clients 201. Then, the server 202 estimates each client's gradient of loss with respect to W by applying a zero-order optimization operation and aggregates the gradients of different clients to generate global gradients by secure aggregation. According to various embodiments, the system for back-propagation-free federated learning utilizes forward propagation rather than back-propagation and thus is more memory efficient and does not require auto-differentiation than a back-propagation-based approach. It is well-adapted to model quantization and pruning as well as inference-only hardware optimization on edge devices. Compared to back-propagation, the computation graph of forward propagation in the system for back-propagation-free federated learning may be more easily optimized, such as by slicing it into per-layer calculation. Since each loss difference Δ [symbol] (W, δₖ; [symbol] _{c}) is a scalar, the system for back-propagation-free federated learning can easily accommodate the uploading bandwidth of clients by adjusting the value of K as opposed to using, e.g., gradient compression. The system for back-propagation-free federated learning is also compatible with inference approaches for TEE providing an efficient approach for combining TEE into FL and preventing white-box evasion.

Experiments on the MNIST and CIFAR-10/100 datasets show that the system for back-propagation-free federated learning achieves comparable performance to conventional FL using a relatively small value of K (as determined by ablation studies) which shows that the system for back-propagation-free federated learning provides an effective back- propagation-free method for FL.

In the following, additional details of the system for back-propagation-free federated learning according to various embodiments are given.

It is assumed that there are C clients (e.g. C=10) and the c-th client's private dataset is [symbol] _{c}:={(Xᵢ^{c}, yᵢ^{c})}ᵢ₌₁^{N}^{_{c}}, i.e. includes N_{c} pairs, each comprising a model input (i.e. a training data input element) and a label (including the ground truth for the model input. Let [symbol] (W; [symbol] _{c}) represent the loss function calculated on the dataset [symbol] _{c}, where W ∈ [symbol] ⁿ denotes the server model's (global) parameters. The training objective of FL is to find parameters W that minimize the total loss function defined as

$$ℒ ( W ) := {\sum }_{c = 1}^{C} \frac{{N}_{c}}{N} ℒ ( W ; {𝔻}_{c} ) \qquad ( 1 )$$

$$where N = {\sum }_{c = 1}^{C} {N}_{c} .$$

As mentioned above, in the standard FL training approach framework, clients 101 locally compute gradients {∇_{w} [symbol] (W; [symbol] _{c})}_{c=1}^{C} or model updates through back-propagation and then upload them to the server. Federated average performs global aggregation using

$$Δ W := {\sum }_{i = 1}^{C} \frac{{N}_{c}}{N} Δ {W}_{c} ,$$

where ΔW_{c} is the local update obtained via executing W_{c}←W_{c}−η∇_{w}_{_{c}} [symbol] (W_{c}; [symbol] _{c}) multiple times and η is a learning rate.

Gradient-based optimization techniques (either first-order or higher-order) may be used to train deep networks. Zero-order optimization methods may also be used for training, particularly when exact derivatives cannot be obtained or backward processes are computationally prohibitive.

Zero-order approaches require only multiple forward processes that may be executed in parallel. Along this routine, finite difference stems from the definition of derivatives and can be generalized to higher-order and multivariate cases by Taylor's expansion. For any differentiable loss function [symbol] (W; [symbol] ) and a small perturbation δ ∈ [symbol] ⁿ, finite difference employs the forward difference scheme

[symbol]

(W+δ; [symbol] )− [symbol] (W; [symbol] )=δ^{T}∇_{w} [symbol] (W+δ; [symbol] )+ο(∥δ∥₂) (2)

where δ^{T}∇_{w} [symbol] (W+δ; [symbol] ) is a scaled directional derivative along 6. Furthermore, the central difference scheme can be used to obtain higher-order residuals as

[symbol]

(W+δ; [symbol] )− [symbol] (W; [symbol] )=2δ^{T}∇_{w} [symbol] (W+δ; [symbol] )+ο(∥δ∥₂²) (3)

Both left hand side terms of equations (2) and (3) can be seen as changes of loss, wherein the one of equation (2) is determined by the difference of the loss of a perturbed version of the model and the loss of a starting version (of the current iteration) of the model and the one of equation (3) is determined by the difference of the losses of two perturbed versions of the model (wherein one is perturbed with a perturbation δ and the other with the opposite −δ of the perturbation).

Finite difference formulas are typically used to estimate quantities such as gradient norm or Hessian trace, where δ is sampled from random projection vectors.

In the following, zero-order optimization techniques for FL and, in particular, the system for back-propagation-free federated learning are described in more detail. One possibility is to apply finite difference as the gradient estimator. To estimate the full gradients, each parameter ω ∈ W may be perturbed to approximate the partial derivative

$$\frac{\partial ℒ ( W ; 𝔻 )}{\partial w} ,$$

causing the forward computations to grow with n (recall that W ∈ [symbol] ⁿ) and thus making it difficult to scale to large machine learning models. In light of this, according to various embodiments, Stein's identity is used to obtain an unbiased estimation of gradients from loss differences calculated on various perturbations. As explained with reference to FIG. 2, the clients 201 need only to download random seeds and model parameter updates, generate perturbations locally, execute multiple forward propagations and upload loss differences back to the server 202.

Deep neural networks can be effectively trained if the majority of gradients have proper signs. Thus, according to various embodiments, where the machine learning model 104 is a deep neural network, forward propagation is performed multiple times on perturbed parameters, in order to obtain a stochastic estimation of gradients without back-propagation. Specifically, assuming that the loss function [symbol] (W; [symbol] ) is continuously differentiable with respect to W given any dataset [symbol] , which is true (almost everywhere) for deep networks using non-linear activation functions, a smoothed loss function

∇_{w} [symbol] _{σ}(W; [symbol] )= [symbol] _{δ˜} [symbol] _{(0,σ}_{²}_{I)} [symbol] (W+δ; [symbol] )

is defined where the perturbation 8 follows a Gaussian distribution with zero mean and covariance σ²I. Given this, Stein's identity states that

$${∇}_{W} {ℒ}_{σ} ( W ; 𝔻 ) = {𝔼}_{δ \sim 𝒩 ( 0 , {σ}^{2} I )} [ \frac{δ}{2 {σ}^{2}} Δℒ ( W , δ ; 𝔻 ) ] \qquad ( 4 )$$

where Δ [symbol] (W, δ; [symbol] ):= [symbol] (W+δ; [symbol] )− [symbol] (W−δ; [symbol] ) is the loss difference. It should be noted that computing a loss difference only requires the execution of two forward processes (e.g., forward passes through the machine-learning model) to compute [symbol] (W+δ; [symbol] ) and [symbol] (W−δ; [symbol] ) without back-propagation. It is straightforward to show that [symbol] _{σ}(W; [symbol] ) is continuously differentiable for any σ>0 and vim; ∇_{w} [symbol] _{σ}(W; [symbol] ) converges uniformly as σ→0. Hence, it follows that

∇_{w} [symbol] (W; [symbol] )=lim_{σ→0}∇_{w} [symbol] _{σ}(W; [symbol] ) (5)

Therefore, a stochastic estimation of gradients can be obtained using Monte Carlo approximation by 1) selecting a small value of σ; 2) randomly sampling K perturbations from [symbol] (0, σ²I) as {σₖ}ₖ₌₁¹ and 3) utilizing the Stein's identity of equation (5) to calculate

$$ℒ ( W ; 𝔻 ) := \frac{1}{K} {\sum }_{k = 1}^{K} [ \frac{{δ}_{k}}{2 {σ}^{2}} Δℒ ( W , {δ}_{k} ; 𝔻 ) ] \qquad ( 6 )$$

In the following, an exemplary algorithm is given.

```
  1: Notations: Se denotes the operations done on servers; Cl denotes the operations done on clients;
    TEE for the TEE module; and [symbol]   denotes the communication process.
  2: Inputs: C clients with local dataset { [symbol]  c }_{c=1}^{C} containing N_{c} input-label pairs,
    $N = {\sum }_{c = 1}^{C} {N}_{c} ; learning rate η , training iterations T , perturbation number K ,$
    noise scale σ.
  3: Se: initializing model parameters W ← W₀;
  4: Se: encoding the computing paradigm into TEE as TEE ∘ Δ [symbol]  (W, δ; [symbol] ); # optional
  5: for t = 0 to T −1 do
  6:  Se [symbol]   all Cl: downloading model parameters Wₜ and the computing paradigm;
  7:  Se [symbol]   all Cl: downloading the random seed sₜ; # 4 Bytes
  8:  Se: sampling K perturbations {δₖ}ₖ₌₁^{K} from [symbol] (0, σ²I) using the random seed sₜ;
  9:  all Cl: negotiating a group of zero-sum noises {ϵ_{c}}_{c=1}^{C} for secure aggregation;
10:  for c = 1 to C do
11:  Cl: sampling K perturbations {δₖ}ₖ₌₁^{K} from [symbol]    (0, σ²I) using the random seed sₜ;
12:  Cl: computing TEE ∘ Δ [symbol]  (Wₜ, δₖ; [symbol] c) via forward propagation for each k;
$13 : Cl ⇒ Se : uploading K outputs \{ TEE ∘ Δℒ ( {W}_{t} , {δ}_{k} ; {𝔻}_{c} ) + \frac{N}{{N}_{c}} {ϵ}_{c} \} \begin{matrix}K \\ k = 1\end{matrix} ; \# 4 \times K Bytes$
14:  end for
$15 : Se : aggregating Δℒ ( {W}_{t} , {δ}_{k} ) ← {\sum }_{c = 1}^{C} \frac{{N}_{c}}{N} [ TEE ∘ Δℒ ( {W}_{t} , {δ}_{k} ; {𝔻}_{c} ) + \frac{N}{{N}_{c}} {ϵ}_{c} ] for each k ;$
$16 : Se : computing ℒ ( {W}_{t} ) ← \frac{1}{K} {\sum }_{k = 1}^{K} \frac{{δ}_{k}}{2 {σ}^{2}} Δℒ ( {W}_{t} , {δ}_{k} ) ;$
17:  Se: Wₜ₊₁ ← Wₜ − η [symbol] [symbol]    (Wₜ);
18: end for
19: Return: final model parameters W_{T}.
```

The algorithm is based on the forward-only gradient estimator [symbol] [symbol] (W; [symbol] ) according to equation (6). The algorithm includes
Model initialization. (Lines 3-4, done by server 202) The server 202 initializes the model parameters to w₀ and optionally encodes the computing paradigm of loss differences Δ [symbol] (W, δ; [symbol] ) into a TEE module 105 which the server 202 (as well as the clients) may optionally include.
Downloading paradigms. (Lines 6-7, server 202 to all clients 201) In round (iteration) t, the server 202 distributes the most recent model parameters Wₜ (or the model update ΔWₜ=Wₜ−Wₜ₋₁) and the computing paradigm to all the C clients 201. In addition, in some embodiments of the system for back-propagation-free federated learning, the server 202 sends a random seed sₜ (rather than directly sending the perturbations to reduce communication burden);
Local computation. (Lines 11-12, done by clients 201) Each client 201 generates K perturbations {δₖ}ₖ₌₁^{K} locally from [symbol] (0, σ²i) using the random seed sₜ and executes the computing paradigm to obtain loss differences. K may be chosen adaptively based on clients' upload bandwidth and computation capability. In some embodiments, K may be determined by each client 201 based on the computation capability of the client 201 and/or the upload bandwidth. In other embodiments, K may be determined by the server 202;
Uploading loss differences. (Line 13, all clients to server) Each client 201 uploads K noisy outputs

$$\{ Δℒ ( {W}_{t} , {δ}_{k} ; {𝔻}_{c} ) + \frac{N}{{N}_{c}} {ϵ}_{c} \} \begin{matrix}K \\ k = 1\end{matrix}$$

to the server 202, where each output is a floating-point number and the noise ϵ_{C} is negotiated by all clients to be zero-sum (i.e. to sum to zero over all the clients; for example, one client may receive an indication of the noises used by the other noises and set its noise such that the sum of noises including the client's noise is zero). The Bytes uploaded for K noisy outputs is 4×K;
Secure aggregation. (Lines 15-16, done by server) In order to prevent the server 202 from recovering the exact loss differences and causing privacy leakage a secure aggregation method is applied. Specifically, all clients negotiate a group of noises {ϵ_{c}}_{c=1}^{C} satisfying Σ_{c=1}^{C} ϵ_{c}=0. The gradient estimator can then be reorganized as

$$ℒ ( {W}_{t} ) = \frac{1}{K} {\sum }_{c = 1}^{C} \frac{{N}_{c}}{N} {\sum }_{k = 1}^{K} [ \frac{{δ}_{k}}{2 {σ}^{2}} Δℒ ( {W}_{t} , {δ}_{k} ; {𝔻}_{c} ) ] = \frac{1}{K} {\sum }_{k = 1}^{K} \frac{{δ}_{k}}{2 {σ}^{2}} Δℒ ( {W}_{t} , {δ}_{k} ) \qquad ( 7 )$$

$$where Δℒ ( {W}_{t} , {δ}_{k} ) = {\sum }_{c = 1}^{C} \frac{{N}_{c}}{N} [ Δℒ ( {W}_{t} , {δ}_{k} ; {𝔻}_{c} ) + \frac{N}{{N}_{c}} {ϵ}_{c} ] .$$

Since {ϵ_{c}}_{c=1}^{C} it holds that

$$Δℒ ( {W}_{t} , {δ}_{k} ) = {\sum }_{c = 1}^{C} \frac{{N}_{c}}{N} Δℒ ( {W}_{t} , {δ}_{k} ; {𝔻}_{c} )$$

and equation (7) holds. Thus, the server 202 can correctly aggregate Δ [symbol] (Wₜ, δₖ) and protect client privacy without recovering individual Δ [symbol] (Wₜ, δₖ; [symbol] _{c}).

It should be noted that after calculating the gradient estimation [symbol] [symbol] (Wₜ), the server 202 updates the parameters to Wₜ₊₁ using techniques such as gradient descent with learning rate ij. The form of the system for back-propagation-free federated learning presented in the above algorithm corresponds to a federated optimization algorithm where lines 11-12 are executed once for each round t. The system for back-propagation-free federated learning can be generalized to an approach in which each client updates its local parameters in multiple steps using the gradient estimator [symbol] [symbol] (Wₜ, [symbol] _{c}) derived from Δ [symbol] (Wₜ, δₖ; [symbol] _{c})r) via equation (6) via gradient descent and uploads model updates to the server 202 which combines these updates to an aggregated update of the model.

Regarding convergence, it can be shown that [symbol] [symbol] (W; [symbol] ) provides an unbiased estimation for the true gradients with convergence rate

$$𝒪 ( \frac{1}{\sqrt{K}} ) .$$

It should be noted that an extremely small 6 will cause an underflow problem and a large K increases computational cost. So, for example, σ is set to 10⁻⁴ because it is a small value that does not cause numerical problems in exemplary use cases and works well on edge devices with half-precision floating-point numbers. K may be chosen in a broad range like 100 to 5000. It may be small (e.g., K=500) relative to the number of model parameters (which is e.g. 3.0×10⁵).

Various embodiments may be used in different computing environments with different entities (e.g., client/server implementations), constraints, and/or use cases. Depending on the computing environment, various techniques may be used to improve accuracy, computational efficiency, or both.

Although either scheme may be used, according to some embodiments, the forward difference scheme (according to equation (2) is used twice forward difference (twice-FD) rather than the central scheme according to equation (3)) since experiments show that central scheme produces smaller residuals than the forward scheme by executing twice as many forward inferences, i.e. W±δ but the linearity of the forward difference scheme reduces the impact from second-order residuals.

In some embodiments, Hardswish activation function may be used as an alternative to ReLU in the machine learning model to overcome the issue of a value jump when the sign of feature changes after perturbation, i.e. h(W+δ)·h(W)<0 where h(.) denotes the feature mapping of the machine learning model.

Further, in some embodiments, exponential moving average (EMA) may be used to reduce oscillations caused by white noise. Regarding normalization, GroupNorm may be used as opposed to BatchNorm since on edge devices, the dataset size is typically small, which leads to inaccurate batch statistics estimation and degrades performance when using BatchNorm.

Since the system for back-propagation-free federated learning according to various embodiments only requires forward propagation, it can be executed in a TEE because it requires little memory. In general, model inference techniques in TEE may be exploited by slicing the computation graph and executing the per-layer forward calculation with constrained memory.

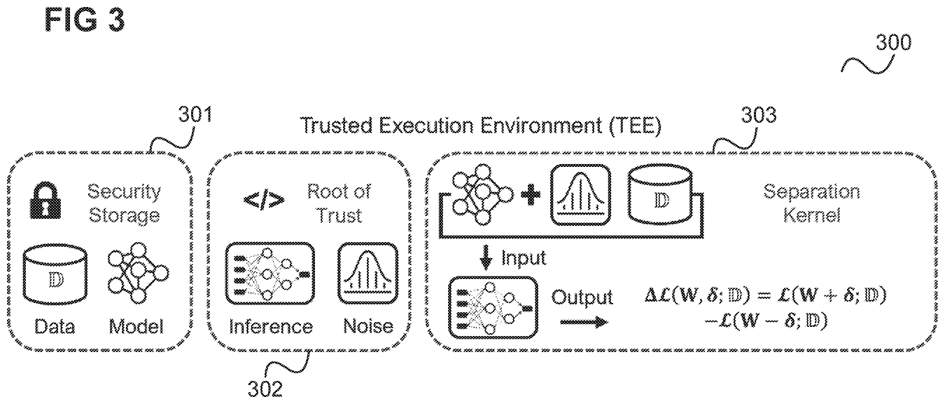

FIG. 3 illustrates a trusted execution environment 300 implemented on a client device (e.g. corresponding to the TEEs 105 on the client devices 101).

The trusted execution environment (TEE) 300 serves to protect against white-box attacks by preventing any model exposure. The TEE 300 protects both data and model security with three components: physical secure storage 301 to ensure the confidentiality, integrity, and tamper-resistance of stored data; a root of trust 302 to load trusted code and a separation kernel 303 to execute code in an isolated environment. Using TEEs, the federated learning system 100 is able to train deep models without revealing any model specifics. The memory is usually being too small (e.g., 90 MB) than what deep models require for back-propagation (e.g., ≥5 GB) but sufficient for forward propagation according to various aspects of the subject technology.

Membership inference attack and model inversion attack are two methods that require an attacker to be able to repeatedly perform model inference on specified data and obtain the results, such as confidence values or classification scores. Given that various aspects of the subject technology provide stochastic loss differences Δ [symbol] (W, δ; [symbol] ) associated with the random perturbation δ, it is difficult to perform inference attacks on systems implemented according to various aspects of the subject technology. It is difficult to distinguish between real data and random noise, indicating that attackers cannot obtain any useful information from outputs from such systems.

In each round's communication, each client 201 uploads a K-dimensional vector to the server 202 and downloads the updated global parameters. Since K is much less than the number of model parameters (e.g., 500 compared to 0.3 million), the system for back-propagation-free federated learning reduces data transfer by roughly half when compared to the pipeline of a back-propagation-based FL system. As to the epoch-level communication settings, a standard back-propagation-based FL system requires each client to perform model optimization on the local training dataset and upload the model updates to the server after a number of local epochs in order to reduce communication costs.

The system for back-propagation-free federated learning can also communicate at the epoch level with O(n) additional memory. An additional memory may be employed to store the perturbation in each forward process and estimate the local gradient using equation (6). After several epochs, each client 201 optimizes the local model with SGD (stochastic gradient descent) and uploads local updates. Compared to the back-propagation-based FL, good performance can be achieved with relatively modest value of K.

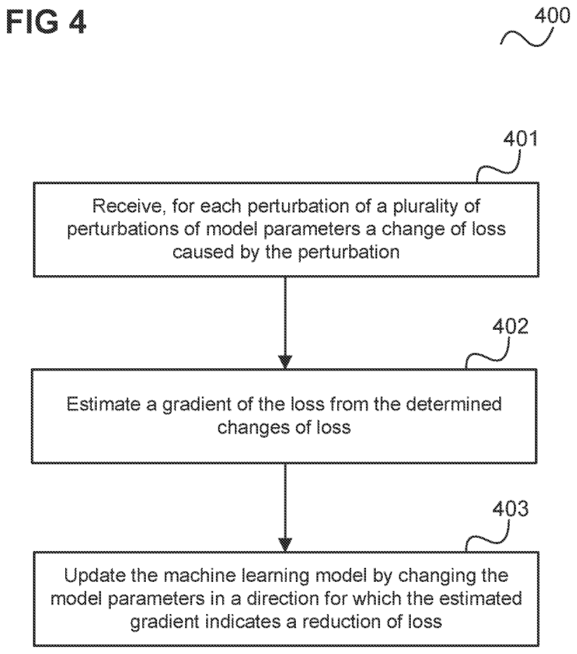

In summary, according to various embodiments, a method is provided as illustrated in FIG. 4.

FIG. 4 shows a flow diagram 400 illustrating a method for training a machine learning model, for example determined by a (federated learning) server.

In 401, for each perturbation of a plurality of perturbations of model parameters of a starting version of the machine learning model, a change of loss of the machine learning model caused by the perturbation for a set of training data is received, wherein the change of loss is determined by feeding the set of training data to one or more perturbed versions of the machine learning model (which are versions of the starting version of the machine learning model perturbed in accordance with the perturbation (or its opposite, i.e. negative) and at least include the version of the starting version of the machine learning model perturbed in accordance with the perturbation).

In 402, a gradient of the loss of the machine learning model with respect to the model parameters is estimated from the determined changes of loss.

In 403, the starting version of the machine learning model is updated to an updated version of the machine learning model by changing the model parameters in a direction for which the estimated gradient indicates a reduction of loss.

According to various embodiments, in other words, rather than performing back-propagation, a machine learning model is trained according to an estimate of a gradient which is determined from the changes of loss caused by perturbations of the model parameters (and observed from forward passes through the perturbed versions of the machine learning model).

The perturbations are randomly generated (e.g., computed based on output generated by a random number generator).

The method of FIG. 4 is for example carried out by a training system which may have an architecture as illustrated in FIG. 1. Specifically, the method of FIG. 4 may be (at least partially) be carried out by the server 102. Each of the clients 101 and the server 102 may for this include a communication interface (e.g. for server-client communication), a processing unit (typically a CPU) and a memory for storing, in particular, model parameters.

A client, e.g. one of the clients 101, may for example carry out a method for training a machine learning model, comprising:

Determining, for each perturbation of a plurality of perturbations of model parameters of a starting version of the machine learning model, a change of loss of the machine learning model caused by the perturbation for a set of training data by feeding the set of training data to one or more perturbed versions of the machine learning model.

Optionally, the method may comprise estimating a gradient of the loss of the machine learning model with respect to the model parameters from the determined changes of loss.

The method may further include transmitting the determined changes of loss to a federated learning server or (in case the method comprises estimating the gradient of the loss) transmitting the estimated gradient to a federated learning server (or both).

According to one embodiment, the method comprises determining the change of loss by determining a perturbed version of the machine learning model whose model parameters are perturbed with respect to the starting version of the machine learning model in accordance with the perturbation and determining the change of loss as the difference of a loss of the starting version of the machine learning model and a loss of the perturbed version of the machine learning model.

According to one embodiment, the method comprises determining the change of loss by determining a first perturbed version of the machine learning model whose model parameters are perturbed with respect to the starting version of the machine learning model in accordance with the perturbation and a second perturbed version of the machine learning model whose model parameters are perturbed with respect to the starting version of the machine learning model in accordance with the opposite of the perturbation and determining the change of loss as the difference of a loss of the first perturbed version of the machine learning model and a loss of the second perturbed version of the machine learning model.

According to one embodiment, the method comprises updating the starting version of the machine learning model to a respective updated version of the machine learning model.

According to one embodiment, the method comprises transmitting the updated version of the machine learning model to a (e.g. federated learning) server for the server to combine the updated version of the machine learning model with one or more updated versions from other clients of the machine learning model to an aggregate update of the machine learning model.

According to one embodiment, the set of training data for different ones of the clients (including the client performing the method and the one or more other clients) are different.

After training the machine learning model, it may for example be used (e.g. by a corresponding controlling device) to control a technical system like e.g. a computer- controlled machine, like a robot (or robotic system), a vehicle, a domestic appliance or a manufacturing machine. According to the use case, the machine learning model's input may be sensor data of different types such as images, radar data, lidar data, thermal imaging data, motion data, sonar data etc. The training includes training input data according to the type of the machine learning model's input data type and labels (i.e. ground truth information) to determine the loss (and the changes of the loss).

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for training a machine learning model, comprising:
receiving, for each perturbation of a plurality of perturbations of model parameters of a starting version of the machine learning model, a change of loss of the machine learning model caused by the perturbation for a set of training data determined by feeding the set of training data to one or more perturbed versions of the machine learning model;
estimating a gradient of the loss of the machine learning model with respect to the model parameters from the determined changes of loss; and
updating the starting version of the machine learning model to an updated version of the machine learning model by changing the model parameters in a direction for which the estimated gradient indicates a reduction of loss.

2. The method of claim 1, further comprising:
distributing the model parameters of the machine learning model to a plurality of clients for the plurality of clients to determine one or more of the changes of loss.

3. The method of claim 2, further comprising:
estimating the gradient of the loss of the machine learning model with respect to the model parameters from the changes of loss determined by the plurality of clients; and
updating the starting version of the machine learning model to the updated version of the machine learning model by changing the model parameters in a direction for which the estimated gradient indicates a reduction of loss.

4. The method of claim 1, further comprising:
transmitting, by a server, one or more seeds to a plurality of clients for the plurality of clients to determine the perturbations using the one or more seeds.

5. The method of claim 1, further comprising performing multiple iterations comprising:
in each iteration from a first to a last iteration, receiving, for each perturbation of a plurality of perturbations of model parameters of a respective starting version of the machine learning model, a change of loss of the machine learning model caused by the perturbation for a set of training data determined by feeding the set of training data to one or more perturbed versions of the machine learning model;
estimating a gradient of the loss of the machine learning model with respect to the model parameters from the determined changes of loss; and
updating the respective starting version of the machine learning model to a respective updated version of the machine learning model by changing the model parameters in a direction for which the estimated gradient indicates a reduction of loss, wherein, for each iteration but the last iteration, the respective updated version of the machine learning model of the iteration is the starting version of the machine learning model for a next iteration.

6. The method of claim 1, further comprising:
estimating the gradient of the loss of the machine learning model with respect to the model parameters from the determined changes of loss according to a Stein's identity.

7. The method of claim 1, wherein the machine learning model is a neural network and wherein the model parameters are neural network weights.

8. A system comprising:
at least one memory; and
at least one processor coupled to the at least one memory, the at least one processor configured to:
receive, for each perturbation of a plurality of perturbations of model parameters of a starting version of a machine learning model, a change of loss of the machine learning model caused by the perturbation for a set of training data determined by feeding the set of training data to one or more perturbed versions of the machine learning model;
estimate a gradient of the loss of the machine learning model with respect to the model parameters from the determined changes of loss; and
update the starting version of the machine learning model to an updated version of the machine learning model by changing the model parameters in a direction for which the estimated gradient indicates a reduction of loss.

9. The system of claim 8, wherein the at least one processor is further configured to:
distribute the model parameters of the machine learning model to a plurality of clients for the plurality of clients to determine one or more of the changes of loss.

10. The system of claim 9, wherein the at least one processor is further configured to:
estimate the gradient of the loss of the machine learning model with respect to the model parameters from the changes of loss determined by the plurality of clients; and
update the starting version of the machine learning model to the updated version of the machine learning model by changing the model parameters in a direction for which the estimated gradient indicates a reduction of loss.

11. The system of claim 8, wherein the at least one processor is further configured to:
transmit, by a server, one or more seeds to a plurality of clients for the plurality of clients to determine the perturbations using the one or more seeds.

12. The system of claim 8, wherein the at least one processor is further configured to:
perform multiple iterations comprising:
in each iteration from a first to a last iteration, receiving, for each perturbation of a plurality of perturbations of model parameters of a respective starting version of the machine learning model, a change of loss of the machine learning model caused by the perturbation for a set of training data determined by feeding the set of training data to one or more perturbed versions of the machine learning model;
estimating a gradient of the loss of the machine learning model with respect to the model parameters from the determined changes of loss; and
updating the respective starting version of the machine learning model to a respective updated version of the machine learning model by changing the model parameters in a direction for which the estimated gradient indicates a reduction of loss,
wherein, for each iteration but the last iteration, the respective updated version of the machine learning model of the iteration is the starting version of the machine learning model for a next iteration.

13. The system of claim 8, wherein the at least one processor is further configured to:
estimate the gradient of the loss of the machine learning model with respect to the model parameters from the determined changes of loss according to a Stein's identity.

14. The system of claim 8, wherein the machine learning model is a neural network and wherein the model parameters are neural network weights.

15. A non-transitory computer-readable storage medium comprising at least one instruction for causing a computer or processor to:
receive, for each perturbation of a plurality of perturbations of model parameters of a starting version of a machine learning model, a change of loss of the machine learning model caused by the perturbation for a set of training data determined by feeding the set of training data to one or more perturbed versions of the machine learning model;
estimate a gradient of the loss of the machine learning model with respect to the model parameters from the determined changes of loss; and
update the starting version of the machine learning model to an updated version of the machine learning model by changing the model parameters in a direction for which the estimated gradient indicates a reduction of loss.

16. The non-transitory computer-readable storage medium of claim 15, wherein the at least one instruction is further configured to cause the computer or the processor to:
distribute the model parameters of the machine learning model to a plurality of clients for the plurality of clients to determine one or more of the changes of loss.

17. The non-transitory computer-readable storage medium of claim 16, wherein the at least one instruction is further configured to cause the computer or the processor to:
estimate the gradient of the loss of the machine learning model with respect to the model parameters from the changes of loss determined by the plurality of clients; and
update the starting version of the machine learning model to the updated version of the machine learning model by changing the model parameters in a direction for which the estimated gradient indicates a reduction of loss.

18. The non-transitory computer-readable storage medium of claim 15, wherein the at least one instruction is further configured to cause the computer or the processor to:
transmit, by a server, one or more seeds to a plurality of clients for the plurality of clients to determine the perturbations using the one or more seeds.

19. The non-transitory computer-readable storage medium of claim 15, wherein the at least one instruction is further configured to cause the computer or the processor to:
perform multiple iterations comprising:
in each iteration from a first to a last iteration, receiving, for each perturbation of a plurality of perturbations of model parameters of a respective starting version of the machine learning model, a change of loss of the machine learning model caused by the perturbation for a set of training data determined by feeding the set of training data to one or more perturbed versions of the machine learning model;
estimating a gradient of the loss of the machine learning model with respect to the model parameters from the determined changes of loss; and
updating the respective starting version of the machine learning model to a respective updated version of the machine learning model by changing the model parameters in a direction for which the estimated gradient indicates a reduction of loss, wherein, for each iteration but the last iteration, the respective updated version of the machine learning model of the iteration is the starting version of the machine learning model for a next iteration.

20. The non-transitory computer-readable storage medium of claim 15, wherein the at least one instruction is further configured to cause the computer or the processor to:
estimate the gradient of the loss of the machine learning model with respect to the model parameters from the determined changes of loss according to a Stein's identity.
